(19) United States
(12) Patent Application Publication
(10) Pub. No.: US 2026/0370825 A1
(43) Pub. Date: Nov. 19, 2026

(54) VIDEO ENCODING/DECODING METHOD AND DEVICE USING SUBBLOCK-BASED GEOMETRIC PARTITIONING MODE

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Dong Gyu Sim, Seoul (KR); Min Hun Lee, Uijeongbu-si (KR); Joo Hyung Byeon, Seoul (KR); Jung Ah Choi, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 19/476,093

(22) PCT Filed: Apr. 11, 2024
(86) PCT No.: PCT/KR2024/004810

§ 371 Date: Oct. 16, 2025

(30) Foreign Application Priority Data
Apr. 18, 2023 (KR) 10-2023-0050445
Apr. 9, 2024 (KR) 10-2024-0048266

(51) Int. Cl. H04N 19/119; H04N 19/159; H04N 19/176

(52) U.S. Cl. CPC H04N 19/119; H04N 19/159; H04N 19/176

(57) ABSTRACT

A video decoding method includes partitioning a current block into a first region and a second region, partitioning the current block into one or more first subblocks that are based on a non-weighted-summation region subject to no weighted summation in the current block and one or more second subblocks that are based on a weighted-summation region subject to a weighted summation in the current block, generating prediction blocks of the one or more first subblocks and prediction blocks of the one or more second subblocks by using an intra-prediction mode of the first region and an intra-prediction mode of the second region, and generating a prediction block of the current block by using the prediction blocks of the one or more first subblocks and the prediction blocks of the one or more second subblocks.

### TECHNICAL FIELD

The present disclosure in some embodiments relates to a video encoding/decoding method and apparatus using a subblock-based geometric partition mode. More particularly, the present disclosure relates to a video encoding/decoding method and apparatus for partitioning a current block when subjected to a geometric partition mode into subblocks and performing prediction per subblock.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

The geometric partition mode is a method of partitioning one coding unit (CU) into two regions, performing inter-prediction independently on the two partitioned regions, and weighted averaging of the two generated inter-prediction signals, to generate a prediction block of the current block. The geometric partition mode needs predictions to be performed in the subblock units to increase encoding efficiency and decoding efficiency.

### DISCLOSURE

### Technical Problem

The present disclosure, in some embodiments, seeks to provide a method and apparatus for partitioning a current block into subblocks based on a geometric partition boundary or a weighted-summation region that is subjected to a weighted summation in a geometric partitioning mode.

The present disclosure also seeks to provide a method and apparatus for performing a prediction in the subblock units in geometric partition mode.

The present disclosure further seeks to provide methods and apparatus for increasing video encoding/decoding efficiency.

The present disclosure further seeks to provide a recording medium storing a bitstream generated by video encoding/decoding methods or apparatus of the present disclosure.

The present disclosure further seeks to provide a method and apparatus for transmitting a bitstream generated by the video encoding/decoding methods or apparatus of the present disclosure.

### SUMMARY

The present disclosure in at least one embodiment provides a video decoding method, including partitioning a current block into a first region and a second region, partitioning the current block into one or more first subblocks that are based on a non-weighted-summation region subject to no weighted summation in the current block and one or more second subblocks that are based on a weighted-summation region subject to a weighted summation in the current block, generating prediction blocks of the one or more first subblocks and prediction blocks of the one or more second subblocks by using an intra-prediction mode of the first region and an intra-prediction mode of the second region, and generating a prediction block of the current block by using the prediction blocks of the one or more first subblocks and the prediction blocks of the one or more second subblocks.

The present disclosure in another embodiment provides a video encoding method, including partitioning a current block into a first region and a second region, partitioning the current block into one or more first subblocks that are based on a non-weighted-summation region subject to no weighted summation in the current block and one or more second subblocks that are based on a weighted-summation region subject to a weighted summation in the current block, generating prediction blocks of the one or more first subblocks and prediction blocks of the one or more second subblocks by using an intra-prediction mode of the first region and an intra-prediction mode of the second region, and generating a prediction block of the current block by using the prediction blocks of the one or more first subblocks and the prediction blocks of the one or more second subblocks.

Further, the present disclosure provides a method of transmitting a bitstream generated by the video encoding methods or apparatus according to the present disclosure.

Further, the present disclosure provides a recording medium storing a bitstream generated by the video encoding methods or apparatus according to the present disclosure.

Further, the present disclosure provides a recording medium storing a bitstream that is received, decoded, and utilized to reconstruct a video by the video decoding apparatus according to the present disclosure.

### Advantageous Effects

As described above, the present disclosure, in some embodiments, can provide a method and apparatus for partitioning a current block into subblocks based on a geometric partition boundary or a weighted-summation region in a geometric partitioning mode.

Further, according to the present disclosure, a method and apparatus for performing a prediction in the subblock units in geometric partition mode can be provided.

Further, the present disclosure can provide methods and apparatus for increasing video encoding/decoding efficiency.

Effects obtainable with the present disclosure are not limited to the above-mentioned effect, and other unmentioned effects could be clearly understood by those skilled in the art from the description below.

### BRIEF DESCRIPTION OF THE DRAWINGS

FIG. 1 is a block diagram of a video encoding apparatus that may implement the techniques of the present disclosure.

FIG. 2 illustrates a method for splitting a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a method of applying a geometric partition mode to a 32×32-block, according to at least one embodiment of the present disclosure.

FIG. 7A and FIG. 7B are diagrams illustrating angle parameters and distance parameters in the geometric partition mode, according to at least one embodiment of the present disclosure.

FIG. 8 is a diagram illustrating a look-up table of partitioning direction information in the geometric partition mode, according to at least one embodiment of the present disclosure.

FIG. 9 is a flowchart of a process of partitioning a current block into subblocks and performing intra prediction on the subblocks, according to at least one embodiment of the present disclosure.

FIG. 10 is a flowchart of a process of using the geometric partition mode based on a subblock, according to at least one embodiment of the present disclosure.

FIG. 11A, FIG. 11B, and FIG. 11C are diagrams illustrating methods of partitioning a current block into subblocks, according to some embodiments of the present disclosure.

FIG. 12A and FIG. 12B are diagrams illustrating a method of partitioning into subblocks of a current block by using its non-weighted-summation region in the geometric partition mode, according to at least one embodiment of the present disclosure.

FIG. 13 is a diagram illustrating a method of partitioning into subblocks of a current block by using its weighted-summation region in the geometric partition mode, according to at least one embodiment of the present disclosure.

FIG. 14 is a diagram illustrating a method of generating prediction blocks of subblocks in the geometric partition mode according to at least one embodiment of the present disclosure.

FIG. 15 is a flowchart of a video decoding process according to at least one embodiment of the present disclosure.

FIG. 16 is a flowchart of a video encoding process according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

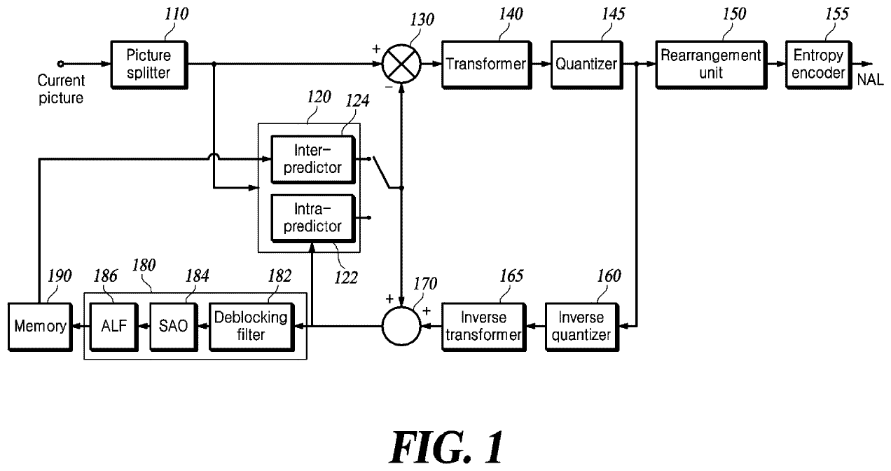

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

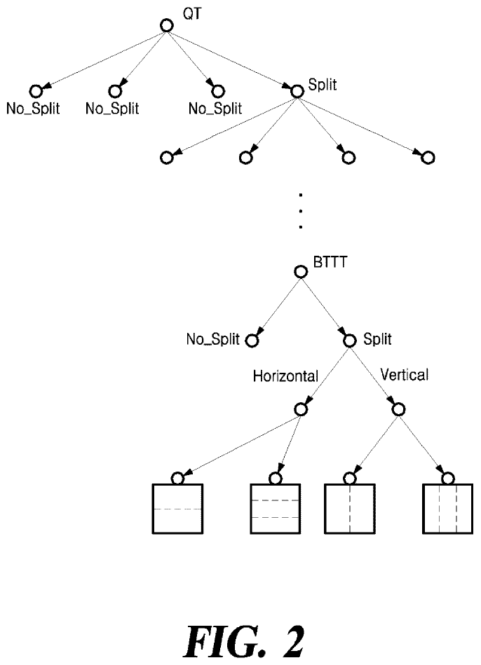

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

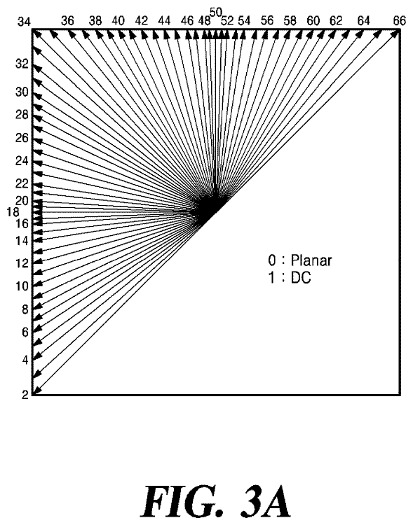

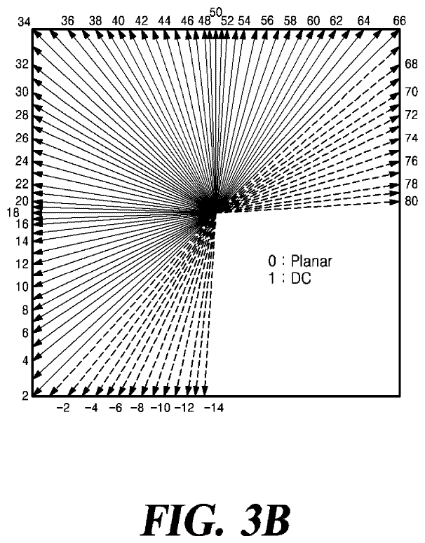

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a bit-rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

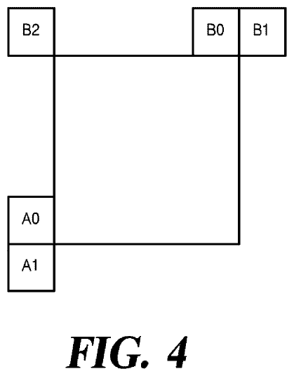

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding apparatus may store a bitstream of encoded video data in a non-transitory storage medium or transmit the bitstream to the video decoding device through a communication network.

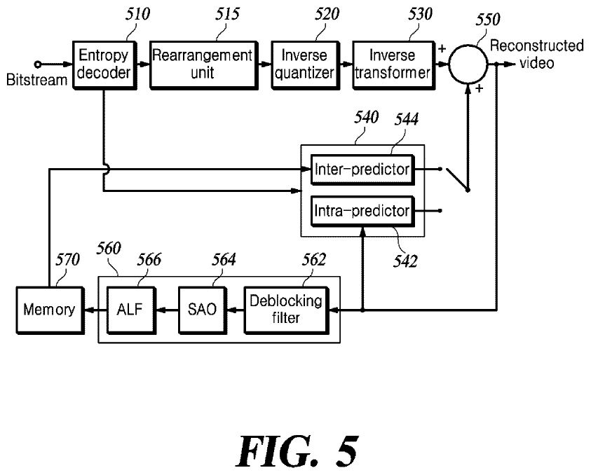

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The following embodiments may be performed by various components in the video encoding apparatus. In addition, they may be performed by various components in the video decoding apparatus.

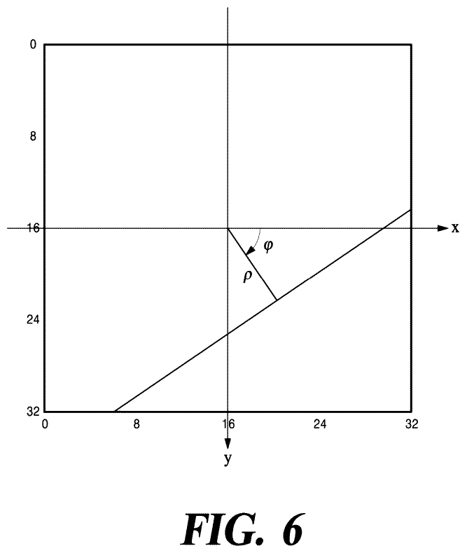

FIG. 6 is a diagram illustrating a method of applying a geometric partition mode to a 32×32-block, according to at least one embodiment of the present disclosure. This diagram is for describing a method of applying the geometric partition mode to a 32×32 block. The geometric partition mode may be described as one coding unit being partitioned into two regions by a straight partition boundary. The two partitioned regions may perform inter prediction by using different pieces of motion information, respectively. Inter-prediction blocks for the two partitioned regions may be generated, respectively. Calculating a weighted average of the two generated inter-prediction blocks may generate a final prediction block of the geometric partition mode. The geometric partition mode sets the partition boundary regions defined by a straight line by using an angle parameter and a distance parameter.

Referring to FIG. 6, the 32×32-block may be partitioned into two regions. Inter prediction may be performed for each of the two partitioned regions. φ may be an angle parameter. ρ may be a distance parameter. A straight line may be established to partition the 32×32 block by using the angle parameter and the distance parameter.

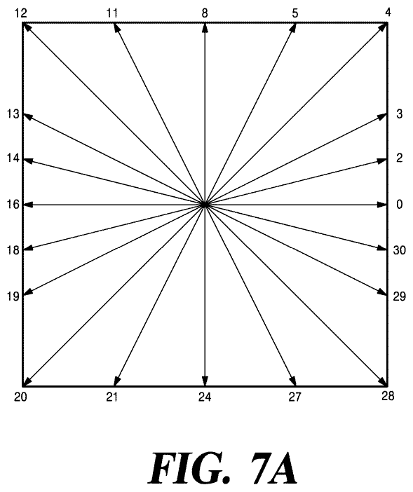

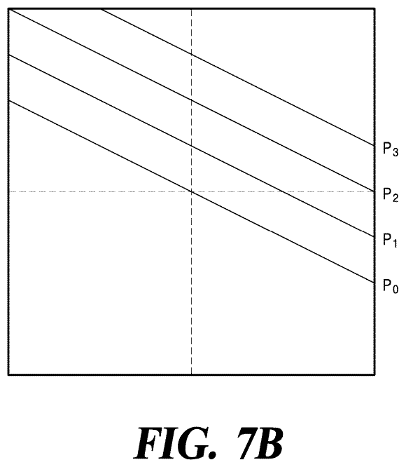

FIG. 7A and FIG. 7B are diagrams illustrating angle parameters and distance parameters in the geometric partition mode, according to at least one embodiment of the present disclosure.

Referring to FIG. 7A, the angle parameter may be defined as a total of 20 quantized angles by symmetrically dividing a 360-degree range in a coding unit.

Referring to FIG. 7B, the distance parameter may be defined as 4 quantized distances. Excluded from a total of 80 partitioning directions that can be generated by combining angle parameters and distance parameters, may be 10 overlapping partitioning directions and 6 overlapping partitioning directions between binary tree partition and ternary tree partition. Accordingly, the geometric partition mode may use a total of 64 partitioning directions.

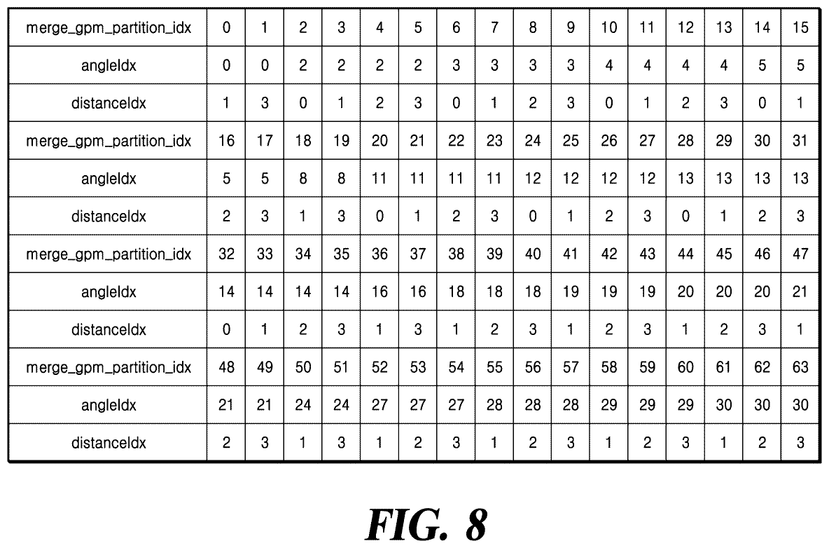

FIG. 8 is a diagram illustrating a look-up table of partitioning direction information in the geometric partition mode, according to at least one embodiment of the present disclosure. Combinations of angle parameters and distance parameters may be defined as a look-up table. Partitioning direction information may be transmitted for each coding unit. The geometric partition mode may construct a merge candidate list for the geometric partition mode that includes only unidirectional motion information from a regular merge candidate list. This can simplify the encoding of motion information and reduce the number of possible combinations of the angle parameters and distance parameters. The merge index used for each partition region may be transmitted by using the merge candidate list for the geometric partition mode.

Referring to FIG. 8, according to the information on the angle parameter (e.g., angleIdx) and the information on the distance parameter (e.g., distanceIdx), the partitioning direction information (e.g., merge_gpm_partition_idx) may be determined. The merge_gpm_partition_idx according to the combination of angleIdx and distanceIdx may be defined as a look-up table. The value of merge gpm partition_idx may be in the range of 0 to 63. The merge_gpm_partition_idx may be transmitted per coding unit.

### Spatial Geometric Partition Mode (SGPM)

SGPM is a mode that applies different intra-prediction modes to each of the two partitioned regions. The video encoding apparatus signals partitioning direction information and an index of a candidate list of two intra-prediction modes combined for the two partitioned regions. A template is used to generate the candidate list of two intra-prediction modes combined, but to reduce the complexity of constructing the candidate list of the two intra-prediction modes combined, 26 out of 64 partition modes are used, and among the 67 intra-prediction modes, the intra-prediction mode derived by most probable mode (MPM), template-based intra mode derivation (TIMD) and decoder-side intra mode derivation (DIMD), the parallel mode for the block boundary of the geometric partition mode, and the perpendicular mode for the block boundary of the geometric partition mode are used.

The candidates of the candidate list of the two intra-prediction modes combined are sorted in ascending order of the template-based Sum of Absolute Transformed Differences (SATD). The length of the candidate list of the combined candidates may be set to 16. The video decoding apparatus determines partitioning direction information by using the signaled index, and uses the signaled index to determine intra-prediction modes for the two regions from the candidate list of the two intra-prediction modes combined. Here, the width of a weighted-summation region that is subjected to a weighted summation in the current block may be implicitly determined based on the height and width of the current block.

### Intra Sub-Partition Mode (ISP Mode)

The ISP mode is adapted to perform intra prediction on the current block subject to the intra prediction after partitioning it into subblocks. The video decoding apparatus partitions the current block into subblocks by using a flag that determines whether the ISP mode is to be performed and a flag that determines whether a vertical partition or a horizontal partition is to be performed. Here, the current block may be partitioned into 2 or 4 subblocks based on the size of the current block. If the current block is partitioned horizontally, the upper subblock is reconstructed first, and then the lower subblock is reconstructed; and if the current block is partitioned vertically, the left subblock is reconstructed first, and then the right subblock is reconstructed. Here, intra prediction may be performed by using the reconstructed sample of the previously reconstructed subblock. When partitioning the current block into subblocks in the ISP mode, to reduce the dependency of intra prediction on subblocks with small sizes, the current block may not be partitioned into a subblock with a width or size of 1 pixel and a subblock with a width or size of 2 pixels.

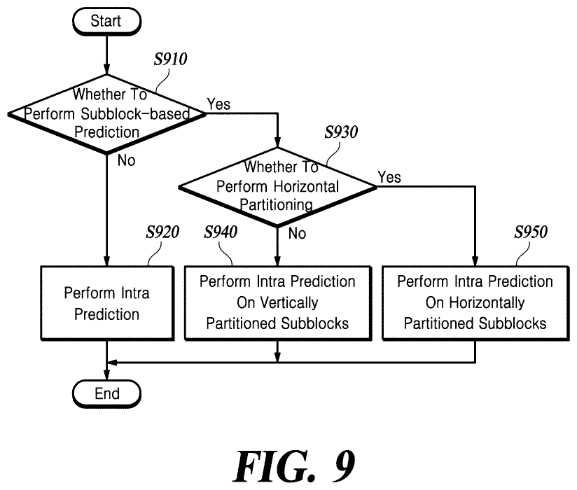

FIG. 9 is a flowchart of a process of partitioning a current block into subblocks and performing intra prediction on the subblocks, according to at least one embodiment of the present disclosure.

Referring to FIG. 9, when intra prediction is performed on the current block, the video decoding apparatus determines whether subblock-based prediction is to be performed (S910). The video decoding apparatus may determine whether subblock-based prediction is to be performed by using a signaled flag. If it is determined not to perform subblock-based prediction (S910—NO), the video decoding apparatus performs intra prediction on the current block (S920). If it is determined to perform subblock-based prediction (S910—YES), the video decoding apparatus determines whether the current block is to be partitioned horizontally (S930). The video decoding apparatus may determine whether the current block is to be partitioned horizontally by using a signaled flag. If it is determined not to partition the current block horizontally (S930—NO), the video decoding apparatus performs intra prediction on the vertically partitioned subblocks (S940). If it is determined to partition the current block horizontally (S930—YES), the video decoding apparatus performs intra prediction on the horizontally partitioned subblocks (S950). Here, the size and number of subblocks used in the prediction process may be different from the size and number of subblocks used in the transform process.

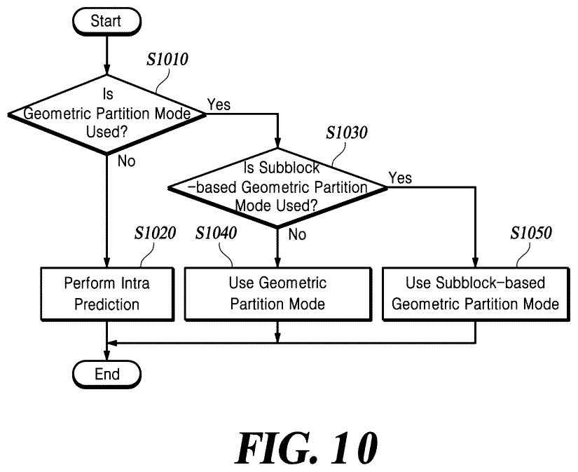

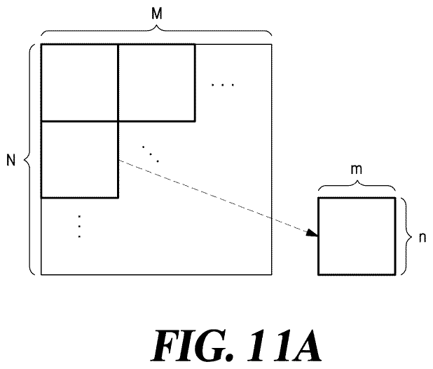

FIG. 10 is a flowchart of a process of using the geometric partition mode based on a subblock, according to at least one embodiment of the present disclosure.

Referring to FIG. 10, when intra prediction is performed on the current block, the video decoding apparatus determines whether the geometric partition mode is applied to the current block (S1010). If it is determined that the geometric partition mode is not applied to the current block (S1010—NO), the video decoding apparatus performs intra prediction on the current block (S1020). If it is determined that the geometric partition mode is applied to the current block (S1010—YES), the video decoding apparatus determines whether the subblock-based geometric partition mode is applied to the current block (S1030). The video decoding apparatus may determine whether the subblock-based geometric partition mode is applied to the current block by using a signaled flag. If it is determined that the subblock-based geometric partition mode is not applied to the current block (S1030—NO), the video decoding apparatus uses the geometric partition mode (S1040). If it is determined that the subblock-based geometric partition mode is applied to the current block (S1030—YES), the video decoding apparatus uses the subblock-based geometric partition mode (S1050).

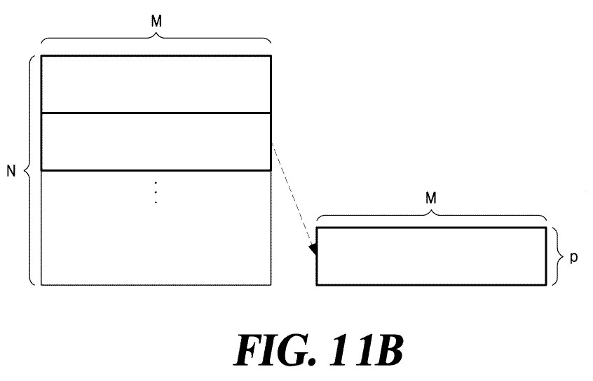

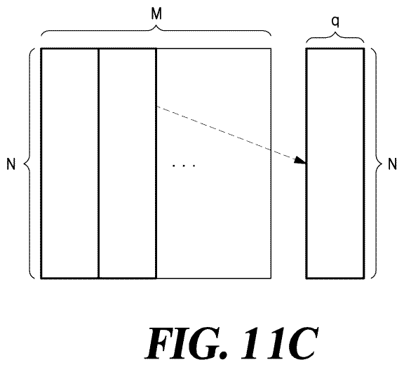

FIGS. 11A, 11B and 11C are diagrams illustrating methods of partitioning a current block into subblocks, according to some embodiments of the present disclosure.

Referring to FIG. 11A, when a subblock-based geometric partition mode is applied to the current block of M×N size, the video decoding apparatus may use m, a divisor of M, and n, a divisor of N to partition the current block into subblocks of m×n size, and perform prediction and reconstruction in units of subblocks of m×n size. Here, the order of prediction and transform performed may be in a set scan order from the subblock on the upper left to the subblock on the lower right.

Referring to FIG. 11B, when the subblock-based geometric partition mode is applied to the current block of M×N size, the video decoding apparatus may partition the current block into subblocks of M×p size by using p, a divisor of N, and perform prediction and reconstruction in units of subblocks of M×p size. Here, the order of prediction and transform performed may be in the order from the upper subblock to the lower subblock.

Referring to FIG. 11C, when the subblock-based geometric partition mode is applied to the current block of M×N size, the video decoding apparatus may partition the current block into subblocks of q×N size by using q, a divisor of M, and perform prediction and reconstruction in units of subblocks of q×N size. Here, the order of prediction and transform performed may be in the order from the left subblock to the right subblock.

When the subblock-based geometric partition mode is applied to the current block of M×N size, a method of partitioning the current block into subblocks may be explicitly determined by using a signaled flag. The method of partitioning the current block into subblocks may be implicitly determined based on the width and length of the current block when the subblock-based geometric partition mode is applied to the current block of M×N size.

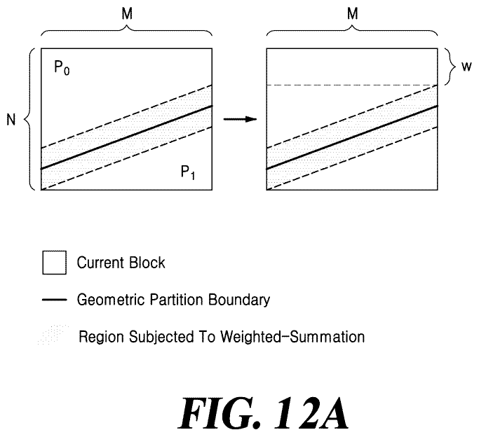

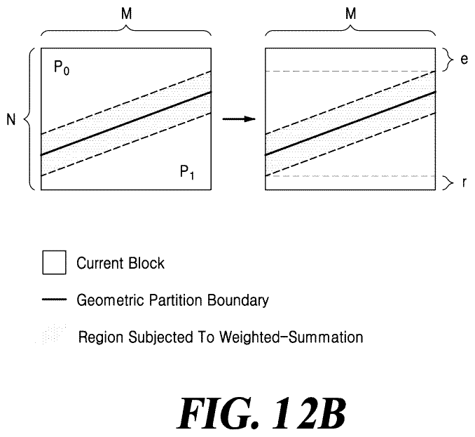

FIG. 12A and FIG. 12B are diagrams illustrating a method of partitioning into subblocks of a current block by using its non-weighted-summation region in the geometric partition mode, according to at least one embodiment of the present disclosure.

Referring to FIG. 12A, when a subblock-based geometric partition mode is applied to the current block of M×N size, the video encoding apparatus may signal partitioning direction information of the current block of M×N size and information on the width of its weighted-summation region. The video decoding apparatus may use the partitioning direction information to partition the current block of M×N size into two regions, P₀ and P₁. The video decoding apparatus uses the information on the width of the weighted-summation region to determine the weighted-summation region in the current block, and uses the weighted-summation region and non-weighted-summation region to partition the current block into subblocks. The video decoding apparatus may utilize the non-weighted-summation region in the current block of M×N size to partition the current block of M×N size into a subblock of M×w size and a block of M×(N−w) size. Here, w may be any positive integer greater than or equal to 1, a multiple of 2, or a power of 2.

Referring to FIG. 12B, when the subblock-based geometric partition mode is applied to the current block of M×N size, the video encoding apparatus may signal partitioning direction information of the current block of M×N size and information on the width of its weighted-summation region. The video decoding apparatus may use the partitioning direction information to partition the current block of M×N size into two regions, P₀ and P₁. The video decoding apparatus uses the information on the width of the weighted-summation region to determine the weighted-summation region in the current block, and uses the weighted-summation region and the non-weighted-summation region to partition the current block into subblocks. The video decoding apparatus may use the non-weighted-summation region in the current block of M×N size to partition the current block of M×N size into subblocks of M×e size, subblocks of M×r size, and blocks of M×(N−e−r) size. Here, e and r may be any positive integer greater than or equal to 1, a multiple of 2, or a power of 2.

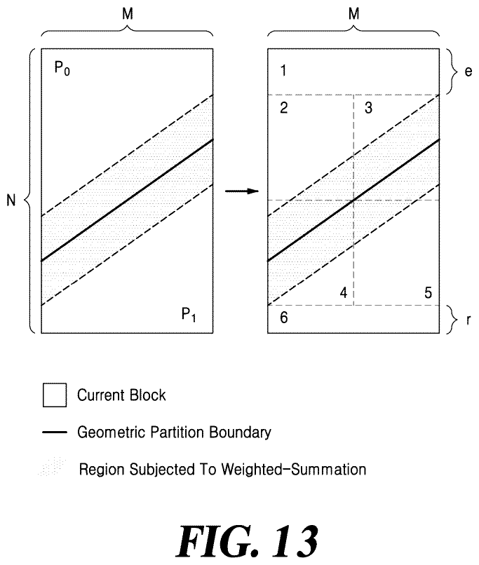

FIG. 13 is a diagram illustrating a method of partitioning into subblocks of a current block by using its weighted-summation region in the geometric partition mode, according to at least one embodiment of the present disclosure.

Referring to FIG. 13, when the subblock-based geometric partition mode is applied to the current block of M×N size, the video decoding apparatus may use partitioning direction information to partition the current block of M×N size into two regions, P₀ and P₁. The video decoding apparatus uses the information on the width of the weighted-summation region to determine the weighted-summation region in the current block, and uses the weighted-summation region and non-weighted-summation region to partition the current block into subblocks. The video decoding apparatus may use the non-weighted-summation region in the current block of M×N size to partition the current block of M×N size into a subblock of M×e size, a subblock of M×r size, and a block of M×(N−e−r) size. Here, e and r may be any positive integer greater than or equal to 1, a multiple of 2, or a power of 2. The subblock of size M×e may be the first subblock, and the subblock of size M×r may be the sixth subblock. The video decoding apparatus may use the weighted-summation region to partition the block of size M×(N−e−r) into four subblocks of the same size. Here, the four subblocks may be a second subblock, a third subblock, a fourth subblock, and a fifth subblock.

For example, the video decoding apparatus may perform prediction and reconstruction in the order of the first subblock, the second subblock, the third subblock, the fourth subblock, the fifth subblock, and the sixth subblock. For example, the video decoding apparatus may determine the order of prediction and reconstruction of the subblocks by using an intra-prediction mode of a region(s) between the P₀ region and the P₁ region, which has a smaller adjacent area to the reconstructed reference samples neighboring the current block. For example, the video decoding apparatus may determine the order of prediction and reconstruction of subblocks by using the intra-prediction mode of the P₀ region and/or the intra-prediction mode of the P₁ region. For example, the video decoding apparatus may use the intra-prediction mode of the P₁ region to perform prediction and reconstruction in the order of the first subblock, the second subblock, the third subblock, the fourth subblock, the fifth subblock, and the sixth subblock. For example, the video decoding apparatus may use the intra-prediction mode of the P₁ region to perform prediction and reconstruction in the order of the first subblock, the sixth subblock, the second subblock, the third subblock, the fourth subblock, and the fifth subblock.

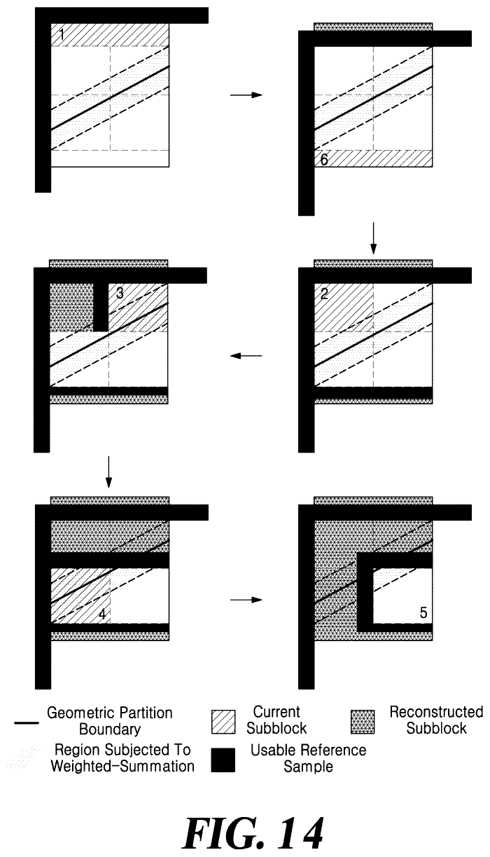

FIG. 14 is a diagram illustrating a method of generating prediction blocks of subblocks in the geometric partition mode according to at least one embodiment of the present disclosure.

As shown in FIG. 14, when the subblock-based geometric partition mode is applied to the current block of M×N size which is then partitioned as shown in FIG. 13 into the first subblock, the second subblock, the third subblock, the fourth subblock, the fifth subblock, and the sixth subblock, the video decoding apparatus may perform the prediction and reconstruction in the order of the first subblock, the sixth subblock, the second subblock, the third subblock, the fourth subblock, and the fifth subblock.

When generating a prediction block of the first subblock, the video decoding apparatus may do it by using reference samples available for the prediction of the first subblock. When generating the prediction block of the sixth subblock, the video decoding apparatus may do it by using reference samples available for the prediction of the sixth subblock. The reference samples available for the prediction of the sixth subblock may include reference samples adjacent to the current block and reference samples of the reconstructed first subblock.

When generating a prediction block of the second subblock, the video decoding apparatus may do it by using reference samples available for the prediction of the second subblock. The reference samples available for prediction of the second subblock may include the reference samples adjacent to the current block, the reference samples of the reconstructed first subblock, and the reference samples of the reconstructed sixth subblock. When generating a prediction block of the third subblock, the video decoding apparatus may do it by using reference samples available for the prediction of the third subblock. The reference samples available for prediction of the third subblock may include the reference samples adjacent to the current block, the reference samples of the reconstructed first subblock, the reference samples of the reconstructed sixth subblock, and the reference samples of the reconstructed second subblock.

When generating a prediction block of the fourth subblock, the video decoding apparatus may do it by using reference samples available for the prediction of the fourth subblock. The reference samples available for prediction of the fourth subblock may include the reference samples adjacent to the current block, the reference samples of the reconstructed first subblock, the reference samples of the reconstructed sixth subblock, the reference samples of the reconstructed second subblock, and the reference samples of the reconstructed third subblock. When generating a prediction block of the fifth subblock, the video decoding apparatus may do it by using the reference samples available for the prediction of the fifth subblock. The reference samples available for prediction of the fifth subblock may include the reference samples adjacent to the current block, the reference samples of the reconstructed first subblock, the reference samples of the reconstructed sixth subblock, the reference samples of the reconstructed second subblock, the reference samples of the reconstructed third subblock, and reference samples of the reconstructed fourth subblock.

Here, since the second subblock, the third subblock, the fourth subblock, and the fifth subblock include the weighted-summation region, the video decoding apparatus may generate prediction blocks of the second subblock, the third subblock, the fourth subblock, and the fifth subblock by using Equation 1. The prediction blocks sbₙ of the subblocks, including the weighted-summation region, may be expressed as in Equation 1.

$${sb}_{n} ( i , j ) = ( {W}_{B}^{f} ( i , j ) \times {P}_{n , 0} + ( {2}^{v} - {W}_{B}^{f} ( i , j ) ) \times {P}_{n , 1} + ( {2}^{v - 1} ) ) ≫ v \qquad [ Equation 1 ]$$

Here, P_{n,0} may be a prediction signal for a region existing in the P₀ region of the current block among the regions of the subblock. P_{n,0} may be a prediction signal generated by using the intra-prediction mode of the P₀ region. P_{n,1} may be a prediction signal for a region existing in the P₁ region of the current block among the regions of the subblock. P_{n,1} may be a prediction signal generated by using the intra-prediction mode of the P₁ region.

$${W}_{B}^{f} ( i , j )$$

may be a weight matrix.

$${W}_{B}^{f} ( i , j )$$

may include coefficients having values of 0 to 2^{v} based on the geometric partition mode of the current block and its weighted-summation region. Here, v may be an integer greater than or equal to 1. W_{B}^{f} (i,j) may include predefined coefficients.

The size of the weighted-summation region may be determined by comparing the slope of the geometric partition boundary with a threshold value. Here, the threshold value may be a value determined by the quantization parameter of the current block. Each coefficient of

$${W}_{B}^{f} ( i , j )$$

may be determined based on the weighted-summation region.

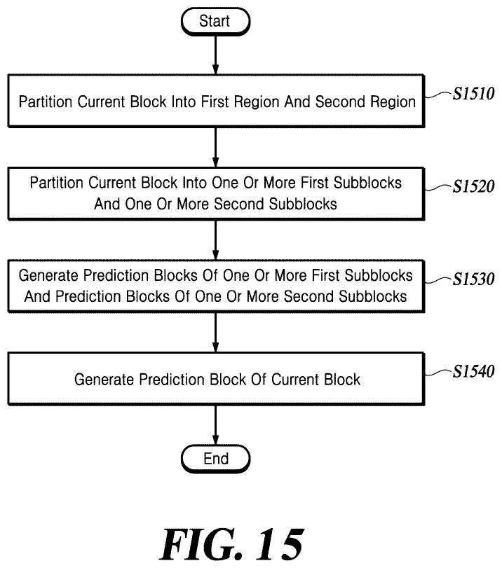

FIG. 15 is a flowchart of a video decoding process according to at least one embodiment of the present disclosure.

Referring to FIG. 15, the video decoding apparatus partitions the current block into a first region and a second region (S1510). The video decoding apparatus partitions the current block into one or more first subblocks based on the non-weighted-summation region in the current block and one or more second subblocks based on the weighted-summation region in the current block (S1520). The one or more second subblocks may be determined based on at least one of the size of the current block, the geometric partition boundary, or the size of the weighted-summation region.

The video decoding apparatus generates prediction blocks of the one or more first subblocks and prediction blocks of the one or more second subblocks by using the intra-prediction mode of the first region and the intra-prediction mode of the second region (S1530). The order of generation of the prediction blocks of the one or more first subblocks and the prediction blocks of the one or more second subblocks may be determined based on at least one of the intra-prediction mode of the first region or the intra-prediction mode of the second region. The prediction blocks of the one or more first subblocks may be generated by using the first reference samples. The prediction blocks of the one or more second subblocks may be generated by using the first reference samples and a first equation. The first reference samples may include neighboring samples of the current block and samples of reconstructed subblocks in the current block. The first equation may be an equation that is based on a prediction signal based on the intra-prediction mode of the first region, a prediction signal based on the intra-prediction mode of the second region, and the weight matrix. The weight matrix may include predefined coefficients.

The video decoding apparatus generates a prediction block of the current block by using the prediction blocks of one or more first subblocks and the prediction blocks of one or more second subblocks (S1540). The prediction block of the current block may be generated by summing the prediction blocks of one or more first subblocks and the prediction blocks of one or more second subblocks.

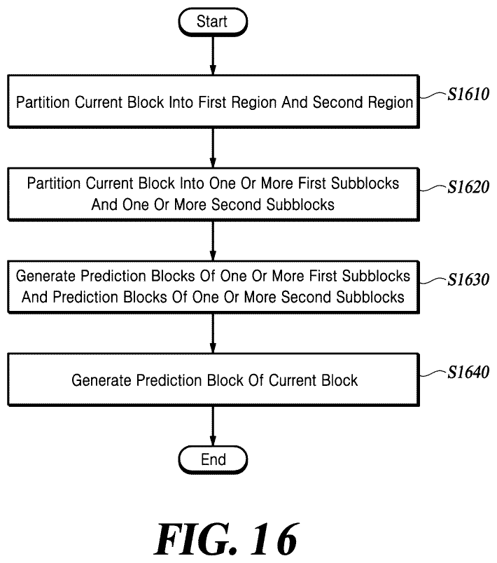

FIG. 16 is a flowchart of a video encoding process according to at least one embodiment of the present disclosure.

Referring to FIG. 16, the video encoding apparatus partitions the current block into a first region and a second region (S1610). The video encoding apparatus partitions the current block into one or more first subblocks that are based on a non-weighted-summation region in the current block and one or more second subblocks that are based on a weighted-summation region in the current block (S1620). The one or more second subblocks may be determined based on at least one of the size of the current block, the geometric partition boundary, or the size of the weighted-summation region.

The video encoding apparatus generates prediction blocks of one or more first subblocks and prediction blocks of one or more second subblocks by using the intra-prediction mode of the first region and the intra-prediction mode of the second region (S1630). The order of generation of the prediction blocks of one or more first subblocks and the prediction blocks of one or more second subblocks may be determined based on at least one of the intra-prediction mode of the first region or the intra-prediction mode of the second region. The prediction blocks of one or more first subblocks may be generated by using the first reference samples. The prediction blocks of one or more second subblocks may be generated by using first reference samples and a first equation. The first reference samples may include neighboring samples of the current block and samples of reconstructed subblocks in the current block. The first equation may be an equation that is based on a prediction signal based on the intra-prediction mode of the first region, a prediction signal based on the intra-prediction mode of the second region, and the weight matrix. The weight matrix may include predefined coefficients.

The video encoding apparatus generates a prediction block of the current block by using the prediction blocks of one or more first subblocks and the prediction blocks of one or more second subblocks (S1640). The prediction block of the current block may be generated by summing the prediction blocks of one or more first subblocks and the prediction blocks of one or more second subblocks.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### CROSS-REFERENCE TO RELATED APPLICATION

This application claims priority from Korean Patent Application No. 10-2023-0050445 filed on Apr. 18, 2023, and Korean Patent Application No. 10-2024-0048266 filed on Apr. 9, 2024, the disclosures of which are incorporated by reference herein in their entirety.

What is claimed is:

1. A video decoding method, comprising:
partitioning a current block into a first region and a second region;
partitioning the current block into one or more first subblocks that are based on a non-weighted-summation region, subject to no weighted summation in the current block, and one or more second subblocks that are based on a weighted-summation region, subject to a weighted summation in the current block;
generating prediction blocks of the one or more first subblocks and prediction blocks of the one or more second subblocks by using an intra-prediction mode of the first region and an intra-prediction mode of the second region; and
generating a prediction block of the current block by using the prediction blocks of the one or more first subblocks and the prediction blocks of the one or more second subblocks.

2. The video decoding method of claim 1, wherein the one or more second subblocks are determined based on at least one of a size of the current block, a geometric partition boundary of the current block, or a size of the weighted-summation region of the current block.

3. The video decoding method of claim 1, wherein the prediction blocks of the one or more first subblocks and the prediction blocks of the one or more second subblocks are generated in a sequence that is determined based on at least one of the intra-prediction mode of the first region or the intra-prediction mode of the second region.

4. The video decoding method of claim 1, wherein generating the prediction blocks of the one or more first subblocks and the prediction blocks of the one or more second subblocks comprises:
generating the prediction blocks of the one or more first subblocks by using first reference samples, and generating the prediction blocks of the one or more second subblocks by using the first reference samples and a first equation,
wherein the first reference samples comprise samples adjacent to the current block and samples of reconstructed subblocks in the current block, and
wherein the first equation is an equation based on a prediction signal based on the intra-prediction mode of the first region, a prediction signal based on the intra-prediction mode of the second region, and a weight matrix.

5. The video decoding method of claim 4, wherein the weight matrix includes predefined coefficients.

6. The video decoding method of claim 1, wherein generating the prediction block of the current block comprises:
generating the prediction block of the current block by summing the prediction blocks of the one or more first subblocks and the prediction blocks of the one or more second subblocks.

7. A video encoding method, comprising:
partitioning a current block into a first region and a second region;
partitioning the current block into one or more first subblocks that are based on a non-weighted-summation region, subject to no weighted summation in the current block, and one or more second subblocks that are based on a weighted-summation region, subject to a weighted summation in the current block;
generating prediction blocks of the one or more first subblocks and prediction blocks of the one or more second subblocks by using an intra-prediction mode of the first region and an intra-prediction mode of the second region; and
generating a prediction block of the current block by using the prediction blocks of the one or more first subblocks and the prediction blocks of the one or more second subblocks.

8. The video encoding method of claim 7, wherein the one or more second subblocks are determined based on at least one of a size of the current block, a geometric partition boundary of the current block, or a size of the weighted-summation region of the current block.

9. The video encoding method of claim 7, wherein the prediction blocks of the one or more first subblocks and the prediction blocks of the one or more second subblocks are generated in a sequence that is determined based on at least one of the intra-prediction mode of the first region or the intra-prediction mode of the second region.

10. The video encoding method of claim 7, wherein generating the prediction blocks of the one or more first subblocks and the prediction blocks of the one or more second subblocks comprises:
generating the prediction blocks of the one or more first subblocks by using first reference samples, and generating the prediction blocks of the one or more second subblocks by using the first reference samples and a first equation,
wherein the first reference samples comprise samples adjacent to the current block and samples of reconstructed subblocks in the current block, and
wherein the first equation is an equation based on a prediction signal based on the intra-prediction mode of the first region, a prediction signal based on the intra-prediction mode of the second region, and a weight matrix.

11. The video encoding method of claim 10, wherein the weight matrix includes predefined coefficients.

12. The video encoding method of claim 7, wherein generating the prediction block of the current block comprises:
generating the prediction block of the current block by summing the prediction blocks of the one or more first subblocks and the prediction blocks of the one or more second subblocks.

13. A method of transmitting a bitstream related to video data,
the method comprising:
generating the bitstream by encoding the video data; and
transmitting the bitstream to a video decoding apparatus,
wherein the generating of the bitstream comprises:
partitioning a current block into a first region and a second region;
partitioning the current block into one or more first subblocks that are based on a non-weighted-summation region, subject to no weighted summation in the current block, and one or more second subblocks that are based on a weighted-summation region, subject to a weighted summation in the current block;
generating prediction blocks of the one or more first subblocks and prediction blocks of the one or more second subblocks by using an intra-prediction mode of the first region and an intra-prediction mode of the second region; and
generating a prediction block of the current block by using the prediction blocks of the one or more first subblocks and the prediction blocks of the one or more second subblocks.
